(19) United States
(12) Patent Application Publication
(10) Pub. No.: US 2009/0318618 A1
(43) Pub. Date: Dec. 24, 2009

(54) POLYMER COMPOSITION FOR AQUEOUS BINDER

(75) Inventors: Takashi MORI, Tokyo (JP); Hiroshi SAKIYAMA, Tokyo (JP); Tomoaki SEKO, Tokyo (JP); Keiichi BESSHO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: JSR CORPORATION, Tokyo (JP)

(21) Appl. No.: 12/411,721

(22) Filed: Mar. 26, 2009

(30) Foreign Application Priority Data
Mar. 28, 2008 (JP) 2008-088280

(51) Int. Cl. C08F 2/32

(52) U.S. Cl. 524/801

(57) ABSTRACT

A polymer composition for aqueous binders includes (1) a polymer obtained by emulsion polymerization of (b) a first monomer having one ethylenically unsaturated bond in the molecule and (c) a second monomer having two or more ethylenically unsaturated bonds in the molecule in the presence of (a) an emulsifier, and (2) a wax.

### BACKGROUND OF THE INVENTION AND RELATED ART

The present invention relates to a polymer composition for aqueous binders that is added to an aqueous ink or the like.

Mixing organic or inorganic fillers with polymer components such as plastic and rubber and applying the mixture to a wide variety of products is being studied. Fillers have excellent characteristics such as a characteristic of improving mechanical properties and thermal properties of polymer components and a characteristic of providing the polymer components with various functions such as magnetic characteristics, electrical characteristics, optical characteristics, vibration suppressing properties, sound insulating properties, hygroscopic properties, oil absorptivity, radiation absorptivity, and the like. However, if used alone, fillers do not necessarily have good processability and formability when producing films or sheets, or other characteristics such as scratch resistance. For this reason, fillers are generally used mixed with polymer binder resins.

Such polymer binder resins are widely used for various materials such as a magnetic coating material, a conductive resin, an optical diffusion film, a friction material, a slide material, a polishing material, an antibacterial resin, a coating material, ink, and the like. As basic properties required of the binder resin used for such applications, the properties of maintaining and improving dispersibility of fillers, providing fillers with scratch resistance by promoting binding properties, increasing adhesiveness of fillers to a substrate, producing a mixture (dispersant) of fillers with a low viscosity, and the like can be given.

As specific examples of binder resins, an urethane resin, a phenol resin, an acrylic resin, a polyester resin, a polyamide resin, polyether, polystyrene, polyester amide, polycarbonate, polyvinyl chloride, a diene polymer, and the like are known. As an aqueous binder resin used for the same applications, emulsions obtained by emulsion polymerization of styrene-butadiene rubber emulsion, an acrylic resin emulsion, and the like (see, for example, Patent Document 1: Japanese Patent No. 3467831); emulsions of polyurethane, polyester, and the like; vinyl alcohol resin emulsions (see, for example, Patent Document 2: JP-A-2000-63728); emulsions of diene polymer sulfonate (see, for example, Patent Document 3: JP-A-10-298206); and the like are generally known. However, these binder resin emulsions do not necessarily have the above-mentioned basic properties. Further improvement of the properties is desired.

As a related general technology, an aqueous emulsion for ink-jet ink obtained by emulsion polymerization of monomers having an ethylenically unsaturated bond in the presence of a reactive emulsifier has been disclosed (see, for example, Patent Document 4: WO 2006/073149). Patent Document 4 describes that if this emulsion is used, scratch resistance, glossiness, and the like of the matter printed by using the aqueous ink-jet ink are improved.

### SUMMARY OF THE INVENTION

However, in certain cases, the effect of improving scratch resistance of printed matter and the like is not necessarily sufficient even if the emulsion disclosed in Patent Document 4 is used. If a wax emulsion is added to the binder resin emulsion in order to further improve the scratch resistance (see, for example, Patent Documents 5: JP-A-2003-261805), the viscosity of the resulting emulsion increases and the storage stability decreases, although the scratch resistance of the printed matter can be improved. In some cases, water resistance of the printed matter also decreases. It has been necessary to solve these problems.

The present invention has been achieved in view of the problems in the related art. An object of the present invention is to provide a polymer composition for aqueous binders that can produce a filler dispersion such as an aqueous ink having a low viscosity, good filler dispersibility, and increased filler bonding properties enabling formation of a coating film with excellent scratch resistance and water resistance.

As a result of extensive studies in order to achieve the above object, the inventors of the present invention have found that the above object can be achieved by a composition comprising a wax and a polymer obtained by emulsion polymerization of specific monomers in the presence of an emulsifier. This finding has led to the completion of the present invention.

According to the present invention, the following polymer composition for aqueous binders is provided.
[1] A polymer composition for aqueous binders comprising (1) a polymer obtained by emulsion polymerization of (b) a first monomer having one ethylenically unsaturated bond in the molecule and (c) a second monomer having two or more ethylenically unsaturated bonds in the molecule in the presence of (a) an emulsifier, and (2) a wax.
[2] The polymer composition for aqueous binders according to [1], wherein the emulsifier (a) is a reactive emulsifier.
[3] The polymer composition for aqueous binders according to [1], wherein the emulsifier (a) has an anionic functional group.
[4] The polymer composition for aqueous binders according to [1], wherein the first monomer (b) is a (meth)acrylic monomer.
[5] The polymer composition for aqueous binders according to [1], wherein the polymer (1) is in the form of particles with a number average particle diameter of 10 to 100 nm dispersed in the state of an aqueous emulsion.
[6] The polymer composition for aqueous binders according to [1], wherein the polymer (1) has a weight average molecular weight of 30,000 to 200,000.
[7] The polymer composition for aqueous binders according to [1], wherein the polymer (1) is obtained by emulsion polymerization in the presence of (d) a chain transfer agent.
[8] The polymer composition for aqueous binders according to [1], the polymer composition being used by being added to an aqueous ink.

The polymer composition for aqueous binders of the present invention can produce a filler dispersion such as an aqueous ink having a low viscosity, good filler dispersibility, and increased filler bonding properties enabling formation of a coating film with excellent scratch resistance and water resistance.

### DESCRIPTION OF PREFERRED EMBODIMENTS

The embodiments for carrying out the present invention are described below. However, the present invention is not restricted to the following embodiments and it should be construed that there are also included, in the present invention, those embodiments in which appropriate changes, improvements, etc. have been made to the following embodiments based on the ordinary knowledge possessed by those skilled in the art, as long as there is no deviation from the gist of the present invention.

A polymer composition for aqueous binders of the present invention comprises (1) a polymer (hereinafter referred to from time to time as “component (1)”) obtained by emulsion polymerization of (b) a first monomer having one ethylenically unsaturated bond in the molecule (hereinafter referred to from time to time as “monomer (b)”) and (c) a second monomer having two or more ethylenically unsaturated bonds in the molecule (hereinafter referred to from time to time as “monomer (c)”) in the presence of (a) an emulsifier, and (2) a wax (hereinafter referred to from time to time as “component (2)”). The details are described below.

### (Emulsifier (a))

The emulsifier is a compound having a hydrophilic group, a hydrophobic group, and a radically reactive group in the molecule. A reactive emulsifier having reactivity can be mentioned as a suitable emulsifying agent. As specific examples of the hydrophilic group, a sulfate group, a carboxylic acid group, and a polyoxyethylene group can be given. Of these hydrophilic groups, the sulfate group and the polyoxyethylene group are preferable. An emulsifier having the sulfate group and the polyoxyethylene group in one molecule is particularly preferable.

As specific examples of the hydrophobic group, an aliphatic alkyl group or an aromatic group having 5 to 20 carbon atoms can be given. Of these, the aliphatic alkyl group having 8 to 15 carbon atoms is preferable. As specific examples of the radically reactive group, ethylenically unsaturated groups such as an acrylic group, a metacrylic group, an allyloxy group, a metallyloxy group, and a propenyl group can be given. Among these, the allyloxy group and propenyl group are preferable. As specific examples of preferably used reactive emulsifiers, compounds having structures of the following general formulas (1) to (6) can be given.

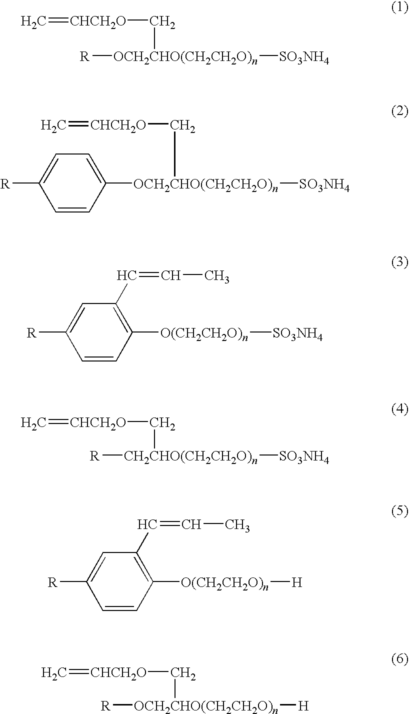

In the above general formulas (1) to (6), R is a hydrocarbon group having 5 to 20 carbon atoms, and n is an integer from 5 to 40. The hydrocarbon group having 5 to 20 carbon atoms shown by R includes an aliphatic alkyl group and an aromatic group.

The hydrophilic group may be an anionic functional group, a cationic functional group, or a nonionic functional group. Any functional groups are preferable. As commercially available reactive emulsifiers having an anionic functional group, “Latemul S-180A” (manufactured by Kao Corp.), “Eleminol JS-2” (manufactured by Sanyo Chemical Industries), “Aqualon KH-10”, “Aqualon HS-10”, and “Aqualon BC-10” (all manufactured by Dai-ichi Kogyo Seiyaku Co., Ltd.), “Adekalia Soap SE-10N” (manufactured by Asahi Denka Ind. Co., Ltd.) are preferably used. Examples of commercially available reactive emulsifiers having a nonionic functional group which are preferably used include “Aqualon RS-20” (manufactured by Daiichi Kogyo Seiyaku Co., Ltd.) and “Adekalia Soap ER-20” (manufactured by Asahi Denka Kogyo K.K.), and the like. A reactive emulsifier having a cationic functional group can also be preferably used. These reactive emulsifiers may be used either individually or in combination of two or more.

Although the amount of the reactive emulsifier used varies according to the number average particle diameter in the case where the polymer (component (1)) is dispersed in an aqueous emulsion in the form of particles, such an amount is preferably 0.5 to 10 parts by mass, and more preferably 0.5 to 5 parts by mass for 100 parts by mass of monomer (b). If below 0.5 parts by mass, not only the emulsification may become insufficient; but also the polymerization reaction tends to be unstable. On the other hand, if exceeding 10 parts by mass, foaming of the resulting aqueous emulsion of the component (1) tends to become a problem.

### (Non-Reactive Emulsifier)

In the case of using the reactive emulsifier, non-reactive emulsifiers such as an anionic emulsifier, a nonionic emulsifier, a cationic emulsifier, an ampholytic emulsifier, and a water-soluble polymer may be used together with the reactive emulsifier. As specific examples of anionic emulsifiers, an alkaline metal salt of higher alcohol sulfuric acid ester, an alkaline metal salt of alkylbenzene sulfonic acid, an alkaline metal salt of dialkylsulfonic acid succinate, an alkaline metal salt of alkyl diphenyl ether disulfonic acid, a sulfate of polyoxyethylene alkyl ether, a phosphate of polyoxyethylene alkyl ether, a phosphate of polyoxyethylene alkyl phenyl ether, and the like can be given.

As specific examples of the nonionic emulsifier, polyoxyethylene alkyl ether, polyoxyethylene alkyl phenyl ether, an alkyl ether having a sugar chain as a hydrophilic group, and the like can be given. Examples of the cationic emulsifier include alkyl pyridinyl chloride alkylammonium chloride, and the like. As specific examples of the ampholytic emulsifier, lauryl betaine and the like can be given.

The amount of the non-reactive emulsifier is usually 5 parts by mass or less for 100 parts by mass of the monomer (b). These non-reactive emulsifiers may be added to the polymerization reaction system in a lump, batchwise or continuously, or by combination of these.

### (Monomer (b))

There are no specific limitations to the molecular structure of the monomer (b) insofar as the monomer has one ethylenically unsaturated bond in the molecule. As specific examples of the monomer (b), aromatic monomers such as styrene, α-methylstyrene, o-methylstyrene, p-methylstyrene, m-methylstyrene, vinyl naphthalene, divinyl styrene; alkyl (meth)acrylates such as methyl (meth)acrylate, ethyl (meth)acrylate, n-propyl (meth)acrylate, i-propyl (meth)acrylate, n-butyl (meth)acrylate, n-amyl (meth)acrylate, i-amyl (meth)acrylate, hexyl (meth)acrylate, 2-ethylhexyl (meth)acrylate, octyl (meth)acrylate, i-nonyl (meth)acrylate, and decyl (meth)acrylate; ethylenically unsaturated carboxylic acid amide such as (meth)acrylamide and N-methylolacrylamide; carboxylic acid vinyl esters such as vinyl acetate and vinyl propionate; anhydrides, monoalkyl esters, and monoamides of ethylenically unsaturated dicarboxylic acid; aminoalkyl ester of ethylenically unsaturated carboxylic acid such as aminoethyl acrylate, dimethylaminoethyl acrylate, and butylaminoethyl acrylate; ethylenically unsaturated carboxylic acid aminoalkylamide such as aminoethylacrylamide, dimethylaminomethylmethacrylamide, and methylaminopropylmethacrylamide; cyanated vinyl compounds such as acrylonitrile and α-chloroacrylonitrile; unsaturated aliphatic glycidyl esters such as glycidyl (meth)acrylate; and functional group-containing monomers containing an alkoxysilane group, a hydroxyl group, or a polyethylene oxide group as a functional group can be given.

As a specific example of the alkoxysilane group-containing monomer containing the alkoxysilane group as a functional group among the above functional group-containing monomers, γ-methacryloxytriethoxysilane can be given. As specific examples of the hydroxyl group-containing monomer containing the hydroxyl group as a functional group, 2-hydroxyethyl (meth)acrylate, hydroxymethyl (meth)acrylate, and hydroxylethyl (meth)acrylate can be given. As specific examples of the polyethylene oxide group-containing monomer containing the polyethylene oxide group as a functional group, polyethylene glycol monomethacrylate (“Blenmer PE200” manufactured by NOF Corp.) and the like can be given.

Styrene, (meth)acrylic monomers, and (meth)acrylonitrile are preferable as monomer (b). As specific examples of the (meth)acrylic monomers, alkyl (meth)acrylates such as methyl (meth)acrylate, ethyl (meth)acrylate, n-butyl (meth)acrylate, and 2-ethylhexyl (meth)acrylate can be given. Among these, the (meth)acrylic monomers are more preferable as the monomer (b). These components (b) may be used individually or in combination of two or more.

### (Monomer (c))

The monomer (c) has two or more ethylenically unsaturated bonds in the molecule. As specific examples of the monomer (c), divinylbenzene and polyfunctional (meth)acrylate can be given. As specific examples of the polyfunctional (meth)acrylate, diacrylate compounds such as polyethylene glycol diacrylate, 1,3-butylene glycol diacrylate, 1,6-butylene glycol diacrylate, 1,6-hexylene glycol diacrylate, neopentyl glycol diacrylate, polypropylene diacrylate, 2,2′-bis(4-acryloxypropyloxyphenyl)propane, 2,2′-bis(4-acryloxydiethoxyphenyl)propane, and the like; triacrylate compounds such as trimethylolpropane triacylate, trimethylolethane triacylate, and tetramethylolmethane triacylate; tetraacrylate compounds such as ditrimethylolpropane tetraacrylate, tetra-methylolmethane tetraacrylate, and pentaerythritol tetraacrylate; dimethacrylate compounds such as ethylene glycol dimethacrylate, dimethylene glycol dimethacrylate, triethylene glycol methacrylate, polyethylene glycol methacrylate, 1,3-butylene glycol dimethacrylate, 1,4-butylene glycol dimethacrylate, 1,6-hexane glycol dimethacrylate, neopentyl glycol dimethacrylate, dipropylene glycol dimethacrylate, polypropylene glycol dimethacrylate, and 2,2-bis(4-methacryloxydiethoxyphenyl)propane; trimethacrylate compounds such as trimethylolpropane trimethacrylate and trimethylolethane trimethacrylate; and methylenebisacrylamide can be given. Of these, ethylene glycol dimethacrylate, trimethylolpropane trimethacrylate, and methylenebisacrylamide are preferable.

The amount of monomer (c) to be used is usually 1 to 30 parts by mass, preferably 2 to 20 parts by mass, and more preferably 3 to 15 parts by mass for 100 parts by mass of monomer (b). If the amount of monomer (c) used is below 1 part by mass for 100 parts by mass of monomer (b), dispersibility of the fillers tends to decrease and viscosity of the ink and the like obtained by mixing with the filler tends to increase. On the other hand, if exceeding 30 parts by mass, scratch resistance tends to decrease.

### (Polymer (1))

The component (1) (polymer (1)) used in the polymer composition for aqueous binders of the present invention can be obtained in the state of an aqueous emulsion, for example, by emulsion polymerization of the monomer (b) and the monomer (c) in the presence of the emulsifier (a). The emulsion polymerization can be carried out using a known method. A radical polymerization initiator is normally used for emulsion polymerization. As specific examples of radical polymerization initiators, redox initiators consisting of an oxidant such as organic hydroperoxides such as cumene hydroperoxide, diisopropylbenzene peroxide, and diisopropylbenzene hydroperoxide, and a reducing agent; persulfates such as potassium persulfate and ammonium persulfate; azo initiators such as azobisisobutyronitrile, dimethyl-2,2′-azobisisobutyrate, and 2-carbamoylazoisobutyronitrile; and organic peroxides such as benzoyl peroxide and lauroyl peroxide can be given. Of these, organic peroxides are preferable.

The amount of the radical polymerization initiator is usually 0.05 to 20 parts by mass, and preferably 0.1 to 10 parts by mass for 100 parts by mass of the monomer (b).

In the emulsion polymerization, 0.5 to 5 parts by mass of the emulsifier (a) and 100 to 5000 parts by mass of water for 100 parts by mass of the monomer (b), and the radical polymerization initiator and, as required, other emulsifiers such as a non-reactive emulsifier, an organic solvent, and the like are used, for example. The polymerization temperature is usually 5 to 100° C., and preferably 30 to 90° C. The reaction time is usually 0.1 to 10 hours, and preferably 2 to 5 hours. The method for adding the monomer (b) and the monomer (c) is not particularly limited. A method of adding the monomer (b) and the monomer (c) at one time, a method of adding the monomer (b) and the monomer (c) continuously, a method of adding the monomer (b) and the monomer (c) in portions, or the like can be arbitrarily employed.

The emulsion polymerization is preferably carried out in the presence of (d) a chain transfer agent. Specific examples of the chain transfer agent that can be used include mercaptans such as octylmercaptan, n-dodecylmercaptan, t-dodecylmercaptan, n-hexadecylmercaptan, n-tetradecylmercaptan, and t-tetradecylmercaptan; xanthogen disulfides such as dimethyl xanthogen disulfide, diethyl xanthogen disulfide, and diisopropyl xanthogen disulfide; thiuram disulfides such as tetramethyl thiuram disulfide, tetraethyl thiuram disulfide, and tetrabutyl thiuram disulfide; halogenated hydrocarbons such as carbon tetrachloride and ethylene bromide; hydrocarbons such as pentaphenylethane 1,1-diphenylethylene and α-methylstyrene dimer; acrolein, methacrolein, allyl alcohol, 2-ethylhexyl thioglycolate, terpinolene, α-terpinene, γ-terpinene, dipentene, and the like. Of these compounds, mercaptans, xanthogen disulfides, thiuram disulfides, carbon tetrachloride, 1,1-diphenylethylene, α-methylstyrene dimer, and 2-ethylhexyl thioglycolate are preferably used. These chain transfer agents may be used either individually or in combination of two or more.

The amount of chain transfer agent to be used is usually 0.1 to 10 parts by mass, preferably 0.2 to 7 parts by mass, more preferably 0.2 to 5 parts by mass, and particularly preferably 0.3 to 3 parts by mass for 100 parts by mass of the monomer (b). If the amount of the chain transfer agent is below 0.1 part by mass for 100 parts by mass of monomer (b), sufficient scratch resistance may not be obtained. If exceeding 10 parts by mass, dispersibility of the fillers tends to decrease. There may be the case in which glossiness and dispersibility decrease. Although the effect of adding the chain transfer agent is not clear, it is thought that the chain transfer agent bonds to polymer terminals contained in the component (1) and causes the mutual solubility with the component (2) (wax (2)) to change, whereby an effect of causing the component (2) to emerge to the coating surface with ease can be exhibited.

The number average particle diameter of the polymer particles dispersed in the aqueous emulsion containing the component (1) obtained in this manner is preferably 10 to 100 nm, and more preferably 30 to 70 nm. The term “number average particle diameter” used herein refers to a value measured using the dynamic light scattering method. If the number average particle diameter of the polymer particles is exceeding 100 nm, storage stability tends to be insufficient. In addition, a uniform coating can be obtained only with difficulty due to fusion bonding, bringing about a tendency of decreasing scratch resistance. If below 10 nm, on the other hand, polymerization stability may be unduly impaired. The number average particle diameter of the polymer particles can be appropriately adjusted by the molecular weight of the component (1), the amount of emulsifier, and the like.

The weight average molecular weight (Mw) of the component (1) is preferably 5000 to 300,000, more preferably 10,000 to 250,000, and particularly preferably 30,000 to 200,000. The weight average molecular weight (Mw) of component (1) can be appropriately adjusted by the selection of the type and amount of the polymerization radical initiator and use of the chain transfer agent.

### (Wax (2))

The component (2) included in the polymer composition for aqueous binders of the present invention is a wax. As specific examples of the component (2), vegetable and animal waxes such as carnauba wax, candelilla wax, beeswax, rice wax, and lanolin; petroleum waxes such as paraffin wax, microcrystalline wax, polyethylene wax, polypropylene wax, polyethylene oxide wax, polypropylene oxide wax, polytetrafluoroethylene wax, and petrolatum; mineral waxes such as montan wax and ozokerite; synthetic waxes such as carbon wax, hext wax, and stearic acid amide; natural and synthetic wax emulsions such as an α-olefin/maleic anhydride copolymer; and compound waxes can be given. Of these, polypropylene wax and polyethylene wax are preferable, with polyethylene wax being particularly preferable. These waxes may be used either individually or in combination of two or more. In addition, it is preferable to use these waxes in the form of an aqueous emulsion by emulsifying with water using a general method.

Among the specific examples of the aqueous emulsion of a wax, as commercially available products, “Aquacer 498”, “Aquacer 535”, “Aquacer 840”, “Aquacer 585” (all manufactured by BYK-Chemie Japan), “High-tech E2215”, “High-tech E2213”, “High-tech E9460”, “High-tech E9015”, “High-tech P9018”, “High-tech P5060P” (all manufactured by TOHO Chemical Industry Co., Ltd.), and the like can be given.

### (Polymer Composition for Aqueous Binders)

The amount of the component (2) included in the polymer composition for aqueous binders of the present invention is usually 5 to 200 parts by mass, preferably 10 to 150 parts by mass, and more preferably 15 to 100 parts by mass of solid components for 100 parts by mass of solid components of the component (1). If the amount of the component (2) is below 5 parts by mass of solid components for 100 parts by mass of the solid components of the component (1), the scratch resistance of the formed coating film tends to be insufficient. If exceeding 200 parts by mass, on the other hand, the water resistance of the coating film tends to decrease.

The polymer composition for aqueous binders of the present invention can be used as a binder composition by mixing with organic or inorganic fillers and dispersing these fillers. As the fillers, fillers for providing a color such as an ink and a paint; fillers for providing mechanical properties such as rigidity, tensile strength, impact resistance, toughness, and slide properties; fillers for providing thermal properties such as heat resistance, thermal expansion properties, and thermic ray emitting properties; fillers for providing electric and magnetic properties such as conductivity, insulation, piezoelectricity, pyroelectric properties, dielectric properties, semiconductor properties, magnetic properties, electromagnetic wave absorptivity, and electromagnetic wave emitting properties; fillers for providing optical properties such as optical transparency, light blocking properties, light scattering properties, light absorbing properties, photochromic properties, UV absorbing properties, infrared absorbing properties, light resistance, and antibacterial properties; and fillers for providing vibration suppressing properties, sound insulating properties, hygroscopic properties, gas absorbing properties, oil absorbing properties, and radiation absorbing properties, and the like can be used.

As specific examples of the fillers, an organic color, carbon black, Ketchen black, graphite, charcoal powder, carbon fiber, iron, silver, copper, lead, nickel, silicon carbide, tin oxide, iron oxide, titanium oxide, magnesium oxide, zinc oxide, cerium oxide, calcium oxide, zirconium oxide, antimony oxide ferrite, alumina, aluminium hydroxide, magnesium hydroxide, potassium titanate, barium titanate, titanic acid, lead zirconate, zinc borate, zinc carbonate, mica, barium sulfate, calcium carbonate, molybdenum sulfide, polytetrafluoroethylene (Teflon™) powder, talc, asbestos, silica bead, glass powder, hydrotalcite, iron phthalocyanine, silica gel, zeolite, sepiolite, xonotlite, activated clay, polymer beads can be given, and the like.

Water is preferably used as a solvent when mixing the polymer composition for aqueous binders of the present invention with the above-described fillers. As required, a small amount of an organic solvent may be added. As preferable examples of the organic solvent that can be added, aromatic solvents such as toluene and xylene; aliphatic solvents such as hexane and heptane; ketones such as acetone and methyl ethyl ketone; ethers such as tetrahydrofuran and dioxane; esters such as ethyl acetate and butyl acetate; and alcohols such as methanol, ethanol, and isopropyl alcohol can be given. These solvents may be used either individually or in combination of two or more.

There are no specific limitations to the method of mixing the polymer composition for aqueous binders of the present invention with fillers. A general method of using a stirrer, a sand mill, a paint conditioner, a ball mill, or the like can be used. A coating can be formed by applying the resulting mixed solution (filler dispersion liquid, binder composition) to a substrate by a general method such as dip coating, spin coating, or bar coating and, as required, vaporizing the solvent such as water at an appropriate temperature.

The proportion of the polymer composition for aqueous binders of the present invention and the filler may differ according to the use of the filler dispersion and cannot be categorically defined. To mention one example, the amount of the polymer composition for aqueous binders, on the solid component basis, is usually 0.3 to 200 parts by mass, and preferably 0.5 to 100 parts by mass for 100 parts by mass of the filler.

In addition to the polymer composition for aqueous binders of the present invention, other binder resins may be added to the filler dispersion. As specific examples of the other binder resins that can be used, aqueous emulsion resins such as a polyester resin, acrylic resin, polystyrene resin, polyvinyl chloride resin, polyvinylidene chloride resin, polyethylene resin, polypropylene resin, polyurethane resin, polyamide resin, polyvinyl acetate resin, polyvinyl alcohol resin, epoxy resin, phenol resin, cellulose resin, polyorganosiloxane resin, polyimide resin, polysulfone resin, and the like can be given.

Optional additives such as a general flame retardant, heat stabilizer, antioxidant, optical stabilizer, releasing agent, plasticizer, coloring agent, lubricant, foaming agent, and the like may be added to the filler dispersion. The mixed solution (filler dispersion, binder composition) of the polymer composition for aqueous binders of the present invention and filler is usually used by being applied to some kind of substrate. There are no particular limitations to the material of the substrate. As specific examples of the substrate, polymer materials such as an acrylic resin, ABS resin, and polybuthyleneterephthalate; nonferreous metals such as aluminum, copper, and duralumin; sheet steel of stainless steel and iron; porous materials such as a fabric and a nonwoven fabric; glass, wood, paper, gypsum, alumina, inorganic cured products, and the like can be given.

The filler dispersion preferably used for various applications can be provided by combining the polymer composition for aqueous binders of the present invention and fillers. Specific applications to which the filler dispersion obtained by using the polymer composition for aqueous binders of the present invention is preferably used include an (aqueous) ink, a general coating material, a coating for circuit boards, a conductive material, a cell material, a cell electrode material, an electromagnetic shielding material, an antistatic coating material, a plane heating element, an electrochemical reaction electrode board, an electrical contact material, a friction material, an antibacterial material, a slide material, an abrasive material, a magnetic recording medium, a thermal record material, an electrochromic material, an optical diffusion film, a water blocking material for communication cables, a shading film, a sound insulation sheet, a plastic magnet, an X-ray intensifying screen, agricultural chemicals granules, electrophotography toner, and the like.

### Examples

The present invention is described in detail below by way of examples. Note that the present invention is not limited to the following examples. In the examples, “part(s)” means “part(s) by mass” and “%” means “mass %” unless otherwise indicated. The methods of measuring and evaluating various properties were as follows.
[Number average particle diameter (Dn)]: Measured according to a general method using laser particle size analyzer (“LPA3100” manufactured by Otsuka Electronics Co., Ltd.).
[Weight average molecular weight (Mw)]: Measured using “SC8010” (GPC manufactured by Tosoh Corp.) under the following conditions utilizing standard polystyrene as a calibration curve.
Eluant: tetrahydrofuran
Column: “G4000HXL” manufactured by Tosoh Corp.
Flow rate: 1,000 μl/min
Column temperature: 40° C.
[Viscosity]: Viscosity of prepared ink was measured at 25° C. using an E-type viscometer.
[Dispersibility]: The number average particle diameter of the filler (titanium oxide) contained in the prepared ink was measured before and after adding synthesized polymer emulsion. The number average particle diameter before and after the addition of the synthesized polymer emulsion are respectively indicated as “P1” and “P2”. “P2/P1” was calculated and dispersibility was evaluated according to the following standard. The number average particle diameter of the filler contained in the ink was measured according to a general method using a laser particle size analyzer (“LPA3100” manufactured by Otsuka Electronics Co., Ltd.).
Good: “P2/P1”<1.1
Fair: 1.1≦“P2/P1”≦1.3
Bad: “P2/P1”>1.3
[Scratch resistance]: The prepared ink was applied to an aluminum plate with a thickness of 0.5 mm using a bar coater (#10) and the coating was dried at 100° C. for one minute to obtain a sample for evaluation having a coating layer (coating film). The sample for evaluation was cut into a diskette with a diameter of 11 cm, which was secured to a rotation board of the main body of a “Rotary Abrasion Tester” (manufactured by Toyo Seiki Seisaku-Sho, Ltd.). After applying a 250 g load using a rotation board equipped with a wear ring, the rotation board was rotated at 60 rpm for one minute. Then, damages to the sample of the coating film for evaluation were observed to evaluate the scratch resistance according to the following standard.
Good: There are almost no blemishes and delamination of the coating film.
Fair: There is a blemish or delamination in part of the coating film.
Bad: There is a significant blemish or delamination of the coating film.
[Water resistance]: The prepared ink was applied to an aluminum plate with a thickness of 0.5 mm using a bar coater (#10) and the coating was dried at 100° C. for one minute to obtain a sample for evaluation having a coating layer (coating film). After dipping the sample for evaluation in water at 25° C. for 30 minutes, the surface of the coating film was observed to evaluate water resistance according to the following standard.
Good: There is no delamination or dropout of the coating film at all.
Fair: There is delamination at a proportion of 10% or less of the total area of the coating film.
Bad: There is delamination at a proportion of exceeding 10% of the total area of the coating film.

### Reference Example 1

A 500 ml beaker was charged with 200 g of water, 3 g of acrylic acid, 1 g of sulfate reactive emulsifier (“Aqualon KH-10” manufactured by Dai-ichi Kogyo Seiyaku Co., Ltd.), 80 g of styrene, 20 g of butyl acrylate, 10 g of methylenebisacrylamide, and 2 g of 2-ethylhexyl thioglycolate. The mixture was stirred at 100 rpm for 10 minutes to obtain a monomer emulsion liquid. A 1 l separable flask was charged with 200 g of water and 1 g of a sulfate reactive emulsifier (“Aqualon KH-10” manufactured by Dai-ichi Kogyo Seiyaku Co., Ltd.). After stirring at 180 rpm, the mixture was heated to 60° C., 2 g of ammonium persulfate was added, and the resulting mixture was heated to 70° C. The previously prepared monomer emulsion liquid was sequentially added over three hours to polymerize the monomers while maintaining the polymerization temperature at 75° C. After the polymerization, the polymer solution was heated to 80° C. and aged for one hour, and 10% ammonia aqueous solution was added to neutralize the solution to 7.0 pH at room temperature. The resulting solution was diluted with water to make the solid-component concentration 15% to obtain the polymer emulsion (Reference Example 1). The number average particle diameter (Dn) of the polymer particles contained in the prepared polymer emulsion was 50 nm. The weight average molecular weight (Mw) of the polymer in the polymer emulsion was 100,000.

### Reference Examples 2 to 11

Polymer emulsions (Reference Examples 2 to 11) were prepared in the same manner as in Reference Example 1 except for using component formulations shown in Table 1. The number average particle diameter (Dn) of the polymer particles contained in the prepared polymer emulsions and the weight average molecular weight of the polymers are shown in Table 2. The abbreviations in Table 1 have the following meanings.
a-1: “Aqualon KH-10” (a sulfate reactive emulsifier manufactured by Dai-ichi Kogyo Seiyaku Co., Ltd.)
a-2: “Aqualon RS-20” (a nonionic reactive emulsifier manufactured by Dai-ichi Kogyo Seiyaku Co., Ltd.)
a-3: Sodium dodecylbenzenesulfonate (non-reactive emulsifier)
ST: Styrene
MMA: Methyl methacrylate
BA: n-Butyl acrylate
2EHA: 2-Ethylhexyl acrylate
c-1: Methylenebisacrylamide
c-2: Trimethylolpropane triacrylate
c-3: DVB-570 (manufactured by Nippon Steel Chemical Co., Ltd., divinylbenzene content: 57%)

TABLE 1

| | | Component | | | | | | | Component | | | |
|---|---|---|---|---|---|---|---|---|---|---|---|---|
| | Acrylic | (a) | | | Component (b) | | | | (c) | | | Component (d) |
| Amount (g) | acid | a-1 | a-2 | a-3 | ST | MMA | BA | 2EHA | c-1 | c-2 | c-3 | 2-Ethylhexyl thioglycolate |
| Reference | 3 | 2 | — | — | 80 | — | 20 | — | 10 | — | — | 2 |
| Example 1 | | | | | | | | | | | | |
| Reference | 3 | 2 | — | — | — | 80 | — | 20 | 10 | — | — | 2 |
| Example 2 | | | | | | | | | | | | |
| Reference | 3 | 2 | — | — | — | 80 | 20 | — | — | 5 | — | 2 |
| Example 3 | | | | | | | | | | | | |
| Reference | 3 | 2 | — | — | — | 50 | 50 | — | — | 5 | — | 2 |
| Example 4 | | | | | | | | | | | | |
| Reference | 3 | — | 2 | — | — | 80 | — | 20 | 10 | — | — | 2 |
| Example 5 | | | | | | | | | | | | |
| Reference | 3 | 2 | — | — | 80 | — | 20 | — | 10 | — | — | — |
| Example 6 | | | | | | | | | | | | |
| Reference | 3 | 2 | — | — | — | 80 | — | 20 | 1 | — | — | 2 |
| Example 7 | | | | | | | | | | | | |
| Reference | 3 | 2 | — | — | — | 80 | — | 20 | 25 | — | — | 2 |
| Example 8 | | | | | | | | | | | | |
| Reference | 3 | — | — | 2 | — | 80 | 20 | — | — | 5 | — | 2 |
| Example 9 | | | | | | | | | | | | |
| Reference | 3 | 2 | — | — | — | 80 | 20 | — | — | — | — | 2 |
| Example 10 | | | | | | | | | | | | |
| Reference | 3 | 2 | — | — | 80 | — | 20 | — | — | — | 10 | 2 |
| Example 11 | | | | | | | | | | | | |

TABLE 2

| | Number average | Weight average |
|---|---|---|
| | particle diameter (nm) | molecular weight (Mw) |
| Reference Example 1 | 50 | 100000 |
| Reference Example 2 | 55 | 90000 |
| Reference Example 3 | 45 | 95000 |
| Reference Example 4 | 50 | 102000 |
| Reference Example 5 | 50 | 110000 |
| Reference Example 6 | 60 | 220000 |
| Reference Example 7 | 50 | 85000 |
| Reference Example 8 | 50 | 250000 |
| Reference Example 9 | 50 | 90000 |
| Reference Example 10 | 50 | 80000 |
| Reference Example 11 | 55 | 100000 |

### (Preparation of Aqueous Titanium Oxide Slurry)

A 1 l polymer bottle was charged with 10 g of styrene/acrylate copolymer (mass ratio: 50/50, molecular weight: 10,000), 300 g of water, 90 g of titanium oxide (“JR600A” manufactured by TAYCA Corp. diameter of primary particles: 0.25 μm), and 30 g of SS balls with a diameter of 4 mm. The content of the bottle was mixed for 30 minutes using a paint conditioner. After removing the SS balls using a nylon mesh, the mixture was diluted with water to make the solid component concentration 10%, thereby obtaining titanium oxide aqueous slurry. The diameter of particles of titanium oxide (diameter of distributed particles) in the resulting titanium oxide aqueous slurry was 0.3 μm.

### Example 1

2 g of the polymer emulsion (solid component concentration: 15%) prepared in Reference Example 1 was mixed with polypropylene wax emulsion (“High-tech P5060P” manufactured by TOHO Chemical Industry Co., Ltd., solid component concentration: 32%) to prepare a polymer composition for an aqueous binders (Example 1). 10 g of titanium oxide aqueous slurry, 7 g of water, and 0.5 g of isopropyl alcohol were added to the prepared polymer composition and the mixture was stirred for 30 minutes using a magnetic stirrer to obtain a white ink containing titanium oxide. The viscosity of the prepared ink was 4.0 mPa·s and the results of dispersibility evaluation were “Good”. The results of scratch resistance evaluation of the coating film of the sample for evaluation prepared from the ink were “Good” and the results of water resistance evaluation were “Good”.

### Examples 2 to 11, and Comparative Example 1

Polymer compositions for aqueous binders (Examples 2 to 11, Comparative Example 1) were prepared in the same manner as in Example 1 except for using component formulations shown in Table 3. A white ink containing titanium oxide was prepared in the same manner as in Example 1. “High-tech E9015” used for preparing the polymer composition for aqueous binders of Example 10 was a polyethylene wax emulsion manufactured by TOHO Chemical Industry Co., Ltd. (solid-component concentration: 40%). The results of viscosity measurement and dispersibility evaluation of the prepared ink are shown in Table 3. The results of scratch resistance evaluation and water resistance evaluation of the coating film of the sample for evaluation prepared from the prepared ink are shown in Table 3.

### Comparative Example 2

1.0 g of polypropylene wax emulsion (“High-tech P5060P” manufactured by TOHO Chemical Industry Co., Ltd., solid component concentration: 32%), 10 g of titanium oxide aqueous slurry, 7 g of water, and 0.5 g of isopropyl alcohol were mixed and the mixture was stirred for 30 minutes using a magnetic stirrer to obtain a white ink containing titanium oxide. The results of viscosity measurement and dispersibility evaluation of the prepared ink are shown in Table 3. The results of scratch resistance evaluation and water resistance evaluation of the coating film of the sample for evaluation prepared from the prepared ink are shown in Table 3.

### Comparative Example 3

2 g of polymer emulsion prepared in Reference Example 3 (solid component concentration: 15%), 10 g of titanium oxide aqueous slurry, 7 g of water, and 0.5 g of isopropyl alcohol were mixed and the mixture was stirred for 30 minutes using a magnetic stirrer to obtain a white ink containing titanium oxide. The results of viscosity measurement and dispersibility evaluation of the prepared ink are shown in Table 3. The results of scratch resistance evaluation and water resistance evaluation of the coating film of the sample for evaluation prepared from the prepared ink are shown in Table 3.

### Comparative Example 4

A white ink containing titanium oxide was prepared without using a polymer component by mixing 10 g of titanium oxide aqueous slurry, 7 g of water, and 0.5 g of isopropyl alcohol and stirring the mixture for 30 minutes using a magnetic stirrer. The results of viscosity measurement and dispersibility evaluation of the prepared ink are shown in Table 3. The results of scratch resistance evaluation and water resistance evaluation of the coating film of the sample for evaluation prepared from the prepared ink are shown in Table 3.

TABLE 3

| | Component (1)*¹ | | Component (2) | | Ink properties | | Coating properties | |
|---|---|---|---|---|---|---|---|---|
| | | Amount | | Amount | Viscosity | | Scratch | Water |
| | Type | (g) | Type | (g) | (mPa · s) | Dispersibility | resistance | resistance |
| Example 1 | Reference Example 1 | 2 | High-tech P5060P*² | 0.25 | 4 | Good | Good | Good |
| Example 2 | Reference Example 2 | 2 | High-tech P5060P | 0.25 | 3.9 | Good | Good | Good |
| Example 3 | Reference Example 3 | 2 | High-tech P5060P | 0.25 | 4.1 | Good | Good | Good |
| Example 4 | Reference Example 4 | 2 | High-tech P5060P | 0.25 | 4 | Good | Good | Good |
| Example 5 | Reference Example 5 | 2 | High-tech P5060P | 0.25 | 4.2 | Good | Good | Good |
| Example 6 | Reference Example 6 | 2 | High-tech P5060P | 0.25 | 4.2 | Good | Fair-Good | Good |
| Example 7 | Reference Example 7 | 2 | High-tech P5060P | 0.25 | 5.5 | Good | Fair-Good | Good |
| Example 8 | Reference Example 8 | 2 | High-tech P5060P | 0.25 | 5 | Good | Fair-Good | Good |
| Example 9 | Reference Example 11 | 2 | High-tech P5060P | 0.25 | 4 | Good | Good | Good |
| Example 10 | Reference Example 1 | 2 | High-tech E9015*³ | 0.25 | 4.1 | Good | Good | Good |
| Example 11 | Reference Example 9 | 2 | High-tech P5060P | 0.25 | 5.8 | Good | Fair-Good | Good |
| Comparative | Reference Example 10 | 2 | High-tech P5060P | 0.25 | 7 | Good | Fair | Good |
| Example 1 | | | | | | | | |
| Comparative | — | — | High-tech P5060P | 1 | 5 | Fair | Fair | Bad |
| Example 2 | | | | | | | | |
| Comparative | Reference Example 3 | 2 | — | — | 4 | Good | Bad | Good |
| Example 3 | | | | | | | | |
| Comparative | — | — | — | — | 3.7 | Good | Bad | Fair |
| Example 4 | | | | | | | | |

*¹Solid content = 15 mass %
*²Solid content = 32 mass %
*³Solid content = 40 mass %

As clear from the results shown in Table 3, the inks prepared using the polymer compositions for aqueous binders of Examples 1 to 11 have a low viscosity, can excellently disperse titanium oxide (filler), and can form a coating film with excellent scratch resistance and water resistance. On the other hand, it is clear that the inks obtained in Comparative Examples 1 to 4 exhibited unfavorable results in at least one item among the viscosity reduction, dispersibility, scratch resistance, and water resistance.

The polymer composition for aqueous binders of the present invention has a low viscosity, good filler dispersibility, and increased filler bonding properties and can produce a filler dispersion liquid which can form a coating film with excellent scratch resistance and water resistance. Therefore, the polymer composition for aqueous binders of the present invention can be suitably used to promote functions of aqueous inks when added thereto.

What is claimed is:

1. A polymer composition for aqueous binders comprising:
(1) a polymer obtained by emulsion polymerization of (b) a first monomer having one ethylenically unsaturated bond in the molecule and (c) a second monomer having two or more ethylenically unsaturated bonds in the molecule in the presence of (a) an emulsifier, and
(2) a wax.

2. The polymer composition for aqueous binders according to claim 1, wherein the emulsifier (a) is a reactive emulsifier.

3. The polymer composition for aqueous binders according to claim 1, wherein the emulsifier (a) has an anionic functional group.

4. The polymer composition for aqueous binders according to claim 1, wherein the first monomer (b) is a (meth)acrylic monomer.

5. The polymer composition for aqueous binders according to claim 1, wherein the polymer (1) is in the form of particles with a number average particle diameter of 10 to 100 nm dispersed in the state of an aqueous emulsion.

6. The polymer composition for aqueous binders according to claim 1, wherein the polymer (1) has a weight average molecular weight of 30,000 to 200,000.

7. The polymer composition for aqueous binders according to claim 1, wherein the polymer (1) is obtained by emulsion polymerization in the presence of (d) a chain transfer agent.

8. The polymer composition for aqueous binders according to claim 1, the polymer composition being used by being added to an aqueous ink.
